(19) United States
(12) Patent Application Publication
(10) Pub. No.: US 2016/0258197 A1
(43) Pub. Date: Sep. 8, 2016

(54) Door Brackets And Hinges For Boltless Storage Racks

(71) Applicant: Silverack, LLC, Brea, CA (US)

(72) Inventors: Dan A. David, La Canada Flintridge, CA (US); Craig Allen, Brea, CA (US)

(21) Appl. No.: 15/061,756

(22) Filed: Mar. 4, 2016

Related U.S. Application Data
(60) Provisional application No. 62/129,617, filed on Mar. 6, 2015.

(51) Int. Cl. E05D 5/02; E05D 5/04

(52) U.S. Cl. CPC E05D 5/0238; E05D 5/046

(57) ABSTRACT

Various adapter brackets for detachably connecting a hinge to a boltless storage rack are presented. Brackets include a first surface having a keyhole-shaped opening and a notch, and a second surface that meets the first surface at a first angle, and having at least one of a rivet and a hole sized and dimensioned to receive a fastener. In some embodiments, at least one of the first opening and the second opening is substantially elongated having a widened area. In some brackets, instead of having a rivet or a hole sized and dimensioned to receive a fastener in the second surface, the brackets have a third surface that meets the second surface at a second angle, and at least one of a rivet and a slot sized and dimensioned to receive a fastener.

This application claims priority to U.S. Provisional Application Ser. No. 61/129,617, filed Mar. 6, 2015, the entire content of which is incorporated herein by reference. All extrinsic materials identified herein are incorporated by reference in their entirety.

### FIELD OF THE INVENTION

The field of the invention is shelving, more specifically, brackets for detachably connecting doors, handles, hooks, baskets, and other devices to a boltless shelving storage rack.

### BACKGROUND

The background description includes information that may be useful in understanding the present invention. It is not an admission that any of the information provided herein is prior art or relevant to the presently claimed invention, or that any publication specifically or implicitly referenced is prior art.

Storage racks and shelving units are commonly used to store a variety of different articles, such as tools and equipment in a garage (e.g., drills, brooms, shovels, extension cords, etc.), in an organized and readily accessible manner. Typical storage racks include left and right end support units and front and rear crossbeams extending between the end support units. Together, the front and rear crossbeams and the end support units define a frame configured to support a shelf for storing various articles. Typically, each end support unit includes front and rear vertical support members (e.g., posts) and cross braces interconnecting the front and rear vertical support members.

One common type of storage rack known in the art is a “boltless” rack, in which at least some of the members of the rack are configured to be assembled without the use of permanent mechanical fasteners. In some conventional boltless racks, the members of the end support units (e.g., vertical support members and cross braces) are permanently coupled together, such as by welding or riveting, and the crossbeams are detachably connected to the vertical support members of the end support units. In other boltless racks, the cross braces are detachable from the vertical support members. Typically, the vertical support members include a series of apertures, such as wedge-shaped slots or keyhole-shaped openings, configured to detachably receive interconnecting members, such as rivets or lances, on opposite ends of the cross beams and cross braces. Accordingly, boltless racks are configured to permit easy assembly and disassembly of the storage rack or shelving unit without the use of tools, and to permit compact and economical shipment of the unit. An example of a boltless shelving unit is shown and described in Applicant's co-pending U.S. patent application Ser. No. 13/360,543, entitled “Modular Rack Assembly,” the entire contents of which are hereby incorporated by reference.

The boltless storage racks described above are typically of an open configuration. It would be advantageous to provide a boltless storage rack that is partially enclosed or fully enclosed to limit access to the stored items. Partially or fully enclosed storage racks are especially useful for storing dangerous items (e.g., chemicals, sharp tools) and expensive items. Partially or fully enclosed storage racks are also useful for esthetic purposes to hide dirty items or excessive clutter. Unfortunately, the boltless storage racks currently available fail to provide a means for covering or securing storage space.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

While various boltless storage racks are known, there is still a need for improved boltless storage racks that provide partially enclosed or fully enclosed storage space.

### SUMMARY OF THE INVENTION

The inventive subject matter provides brackets for detachably connecting hinges to vertical support members of a boltless storage rack using adapter brackets, and methods of attaching adapter brackets to the vertical support members.

One aspect of the inventive subject matter includes a bracket for detachably connecting a hinge to a vertical support member having a plurality of apertures. In a preferred embodiment, the bracket includes a first surface having a keyhole-shaped opening and a notch and a second surface that meets the first surface at a first angle, and having at least one of (i) a rivet and (ii) a hole sized and dimensioned to receive a fastener.

In some embodiments, the bracket includes a first surface having a first opening and a second opening, and a second surface that meets the first surface at a first angle, and having at least one of (i) a rivet and (ii) a hole sized and dimensioned to receive a fastener. In these embodiments, it is preferred that at least one of the first opening and the second opening is substantially elongated having a widened area.

In some other embodiments, the bracket includes a first surface having a keyhole-shaped opening and a notch and a second surface that meets the first surface at a first angle. The bracket in these embodiments further includes a third surface that meets the second surface at a second angle, and having at least one of (i) a rivet and (ii) a slot sized and dimensioned to receive a fastener.

Another aspect of the inventive subject matter includes methods of attaching adapter brackets to a vertical support member. One embodiment of the methods is of attaching a first bracket to the vertical support member having a plurality of apertures and a second bracket having rivets. The first bracket includes a first surface having a keyhole-shaped opening and a notch and a second surface that meets the first surface at a first angle, and having at least one of (i) a rivet and (ii) a hole sized and dimensioned to receive a fastener. having a plurality of apertures and a second bracket having rivets. The method includes steps of 1) positioning the first bracket with the vertical support member to align one rivet or the hole of the bracket with an aperture of the plurality of apertures, 2) sliding the rivet of the first bracket into the aperture or fastening a fastener through the hole of the bracket and the aperture, and 3) sliding at least one rivet of the second bracket into at least one of the keyhole-shaped opening and the notch.

Another embodiment of the methods is attaching a first bracket to the vertical support member having a plurality of apertures and a second bracket having rivets. In this embodiment, the first bracket includes a first surface having a first opening and a second opening, and a second surface that meets the first surface at a first angle, and having at least one of (i) a rivet and (ii) a hole sized and dimensioned to receive a fastener. Preferably, at least one of the first opening and the second opening is substantially elongated having a widened area. In this embodiment, the method includes steps of 1) positioning the first bracket with the vertical support member to align one rivet or the hole of the bracket with an aperture of the plurality of apertures, 2) sliding the rivet of the bracket into the aperture or fastening a fastener through the hole of the first bracket and the aperture, and 3) sliding at least one rivet of the second bracket into at least one of the first opening and the second opening.

Still another embodiment of the methods is attaching a first bracket to the vertical support member having a plurality of apertures and a second bracket having rivets. In this embodiment, the first bracket has a first surface having a keyhole-shaped opening and a notch, and a second surface that meets the first surface at a first angle. Preferably, the first bracket also includes a third surface that meets the second surface at a second angle, and having at least one of (i) a rivet and (ii) a slot sized and dimensioned to receive a fastener. In this embodiment, the methods includes steps of 1) positioning the bracket with the vertical support member to align one rivet or the slot of the bracket with an aperture of the plurality of apertures, 2) sliding the rivet of the bracket into the aperture or fastening a fastener through the slot of the bracket and the aperture, and 3) sliding at least one rivet of the second bracket into at least one of the keyhole-shaped opening and the notch.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 shows a perspective view of one embodiment of a boltless storage rack with a right door unattached.

FIG. 2 shows a perspective view of the boltless storage rack of FIG. 1 with both left and right doors attached.

FIG. 3A shows a perspective view of one embodiment of a hinge assembly.

FIG. 3B shows a perspective view of another embodiment of a hinge assembly.

FIG. 4 shows a perspective view of still another embodiment of a hinge assembly, including an adapter bracket.

FIG. 5 shows a side view of the hinge assembly of FIG. 4 coupled to a vertical support member.

FIG. 6 shows a perspective view of still another embodiment of a hinge assembly.

FIG. 7 shows a side view of the hinge assembly of FIG. 6 coupled to a vertical support member.

FIG. 8 shows a perspective view of still another embodiment of a hinge assembly.

FIG. 9 shows a side view of the hinge assembly of FIG. 8 coupled to a vertical support member.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The inventive subject matter provides apparatus, systems and methods in which an adapter bracket can be used to attach hinges (e.g., door hinges) to the vertical support members of a boltless shelving storage rack. Most typically, the hinge has rivets, or lances, that are spaced apart by a distance that is different than the distance of the apertures on a vertical support member of the boltless shelving storage rack. Consequently, the hinge cannot directly attach to the vertical support members because the rivets or lances cannot be inserted into the apertures of the vertical support members. However, the bracket of the inventive subject matter can be used to attach hinge to boltless shelving storage rack. The bracket has a first surface that has openings to allow the rivets, or lances, of the hinge to be inserted, and a second surface that has a hole and fastener or a rivet to couple with the apertures of the vertical support members.

While the adapter brackets described herein are shown as being used for attaching door hinges to vertical support members, it is also contemplated that the adapter brackets can be used to attach a second brackets (e.g., bracket for a basket, bracket for a hook, etc) to a vertical support member. Examples of secondary brackets are provided in co-owned U.S. patent application Ser. No. 14/601,191, which is incorporated herein by reference in its entirety. Thus, many different secondary brackets can be attached to incompatible boltless shelving storage rack via the bracket of the inventive subject matter.

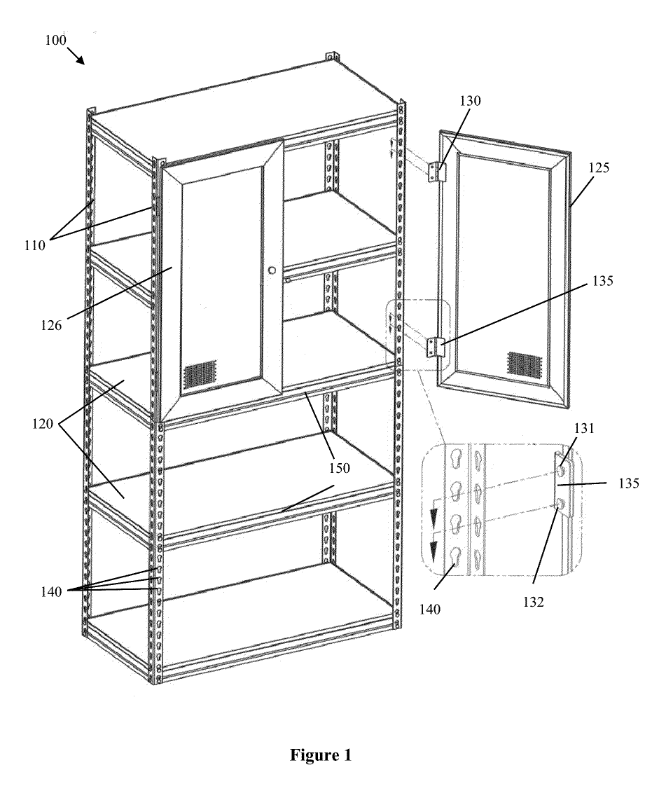

FIG. 1 shows a boltless shelving storage rack 100. Rack 100 has four vertical support members 110 connected by a plurality of shelves 120 and a plurality of crossbeams 150. Shelves 120 and crossbeams 150 are mechanically and removably (e.g., detachably) fastened to vertical support members 110 without the use of bolts or screws. More specifically, each of the vertical support members 110 has a plurality of keyhole-shaped openings 140. Shelves 120 and crossbeams have protrusions or rivets that slidably engage keyhole-shaped openings 140, as described in more detail in co-owned U.S. patent application Ser. No. 14/223,297, which is incorporated herein by reference in its entirety.

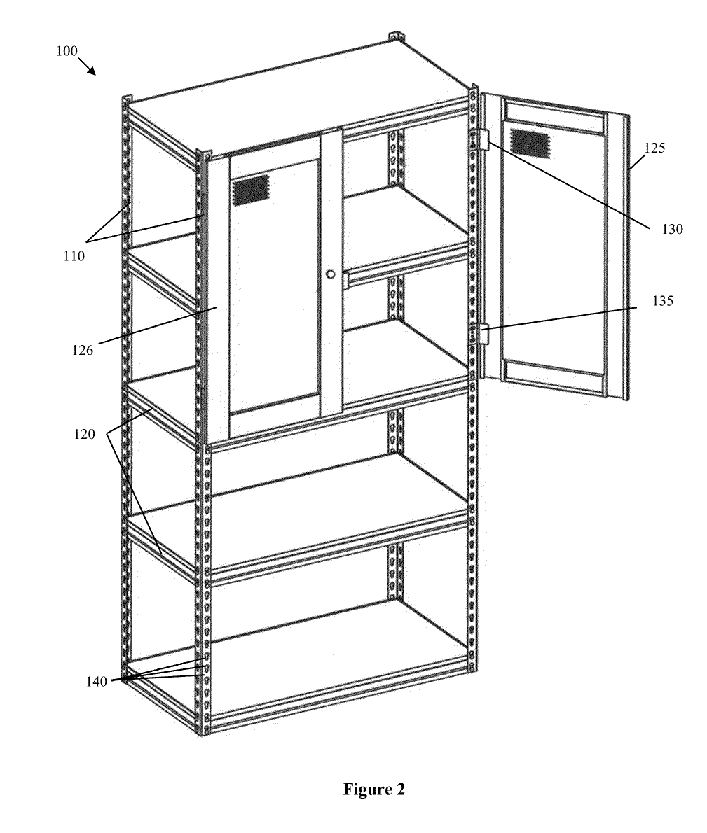

Rack 100 also includes doors 125 and 126, which are also boltlessly attached to vertical support members 110. More specifically, doors 125, 126 have one or more boltless hinge assemblies 130, 135. As shown in FIG. 1, hinge assembly 130 has a first plate and a second plate hingeably coupled at a pivot point (e.g., axis). One of the plates has a pair of rivets 131, 132 that are sized and dimensioned to slidably engage and lock with the keyhole-shaped openings 140 of support members 110. Rivets 131, 132 have a shaft portion and a head portion. The width of the head portion is smaller than the circular end of the keyhole-shaped openings 140, but larger than the elongated end. The width of the shaft portion of the rivets 131, 132 is smaller than the width of the elongated end of the keyhole-shaped openings 140. By inserting the head portion of rivets 131, 132 into openings 140, and by sliding rivets 131, 132 down into the elongated end of openings 140, hinge assembly 130 is mechanically fastened to support members 110 as shown in FIG. 2. Rivets 131, 132 are separated by a distance that is equal to the distance of two adjacent openings 140.

The length of doors 125 and 126 are substantially the distance between two keyhole-shaped openings 140 on the same vertical support member 110. This allows doors 125 and 126 to provide a partial enclosure since one shelf can be attached at the bottom of the door and another shelf can be attached at the top. In the present rack embodiment, the keyhole-shaped openings 140 are equally spaced along the length of each support member 110. As such, the length of doors 125, 126 can be the distance between two adjacent openings 140 times a factor (e.g., 2, 3, 4, 5, etc.). In other words, the length of doors 125, 126 can be determined as a ratio to the distance of two adjacent openings 140. Rack 100 can include multiple doors of different sizes for greater customization.

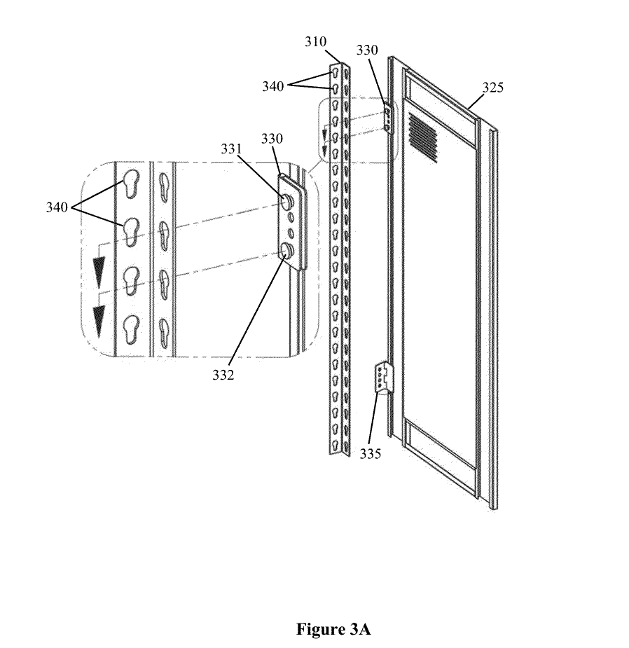

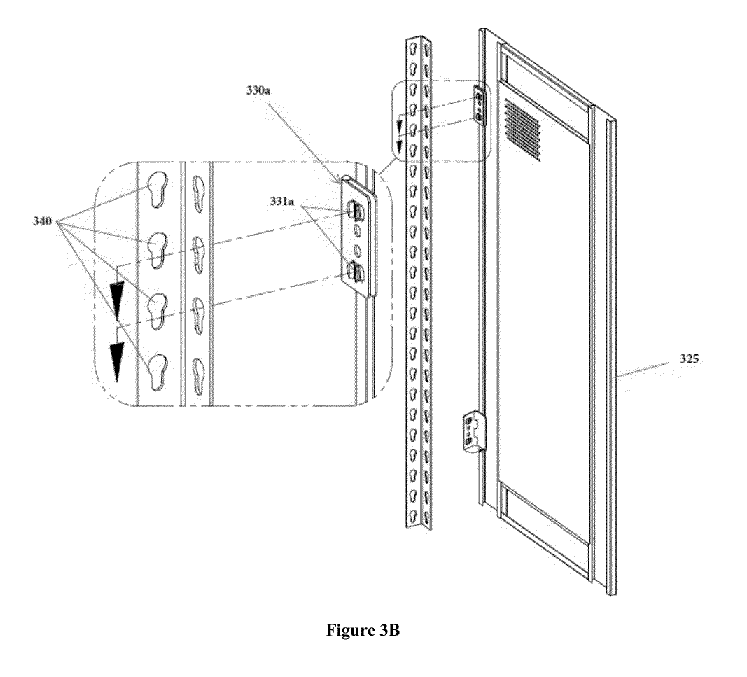

FIG. 3A shows another embodiment of hinge assembly 330 having rivets 331, 332 for coupling with keyhole-shaped openings 340 of support members 310. The head portion of rivets 331, 332 can be inserted into keyhole-shaped openings 340 and slide down to engage the hinge assembly 330 to support member 310. Thus, a user can install a door 325 to a boltless shelving storage rack without the use of bolts or tools.

In other contemplated embodiments, one of the plates can have a pair of butterfly lances, as shown in FIG. 3B. Hinge assembly 330a is similar to assembly 330 except that the rivets 331, 332 have been replaced by butterfly lances 131a. Butterfly lances 331a that are sized and dimensioned to slidably engage and lock with the keyhole-shaped openings 340 of support members 310. Lances 331a have an outer width (e.g., diameter) that is smaller than the circular end (i.e., the wider end) of openings 340, but larger than the elongated end (e.g., the narrower end) of opening 340. As such, lance 331a can be inserted into the circular end and slides down into the elongated end for mechanical engagement. The other plate of hinge assembly 330a is attached to door 325. Hinge assembly 130a thus allows door 335 to detachably and repositionably fasten to support members 310 at different locations and without the use of bolts, using the same keyhole-shaped openings as shelves.

It should be appreciated that in some embodiments, hinge assembly 330, 330a could comprise only one protrusion (e.g., rivet, butterfly lance). In addition, various shapes and configurations of the protrusions other than rivets and butterfly lances are contemplated.

While the embodiments discussed above show that a hinge assembly can be used to couple a door to a boltless shelving storage rack, it should be noted that keyhole-openings may not necessarily align with the rivets or butterfly lances of the hinge assembly in some instances. This misalignment between the keyhole-openings and rivets or butterfly lances can be due to the fact that the hinge assembly and boltless shelving storage rack/vertical support member/keyhole-openings is made by a different manufacture or because at least one of the hinge assembly and boltless shelving storage rack/vertical support member/keyhole-openings belongs to a different model, such that the spacing between the rivets of the hinge assembly is not the same as the spacing between apertures of the vertical support member. Consequently, the hinge assembly cannot be properly coupled to the boltless shelving storage rack.

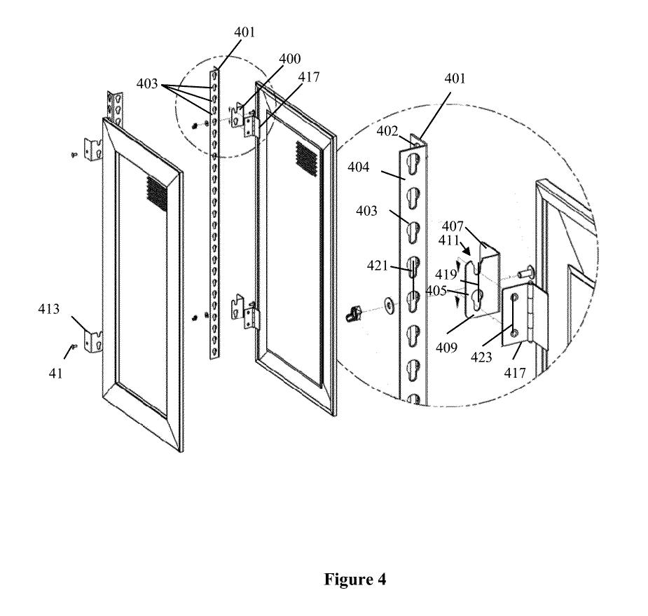

To address potential issues with misalignment between a hinge assembly and a storage rack, the inventors have contemplated a bracket that couples a hinge assembly or any other assemblies (e.g., a bracket assembly, a hook assembly, etc.) to a storage rack. FIG. 4 shows a bracket 400 for detachably connecting to a vertical support member 401 of a storage rack having a plurality of apertures 403. Bracket 400 comprises a first surface 405 and a second surface 407 that meet at a first angle. First surface 405 has a keyhole-shaped opening 409 and a notch 411. As shown in FIG. 4, keyhole-shaped opening includes a relatively larger upper circular opening and a relatively smaller elongated opening extending downward from a lower end of the larger upper circular opening. Notch 411 typically has the shape of a portion of the keyhole-shaped opening as shown in FIG. 4, which includes a portion of the larger upper circular opening and the smaller elongated opening of the keyhole-shaped opening. More details regarding keyhole-shaped openings and notches having the shape of a portion of the keyhole-shaped openings are described in more detail in co-owned U.S. patent application Ser. No. 14/223,297, which is incorporated by reference in its entirety herein.

Second surface 407 has at least one of (i) a rivet and (ii) a hole 413 that is sized and dimensioned to receive a fastener 415. A user can couple bracket 400 onto vertical support member 401 by inserting at least one of a rivet and fastener 415 though at least one aperture 403 of vertical support member 401. A hinge 417 having a first and second rivet can couple onto bracket 400 using keyhole-shaped opening 409 and notch 411 on first surface 405 of bracket 400. While hinge 417 has a first and second rivet, it is contemplated that hinge 417 can have a pair of butterfly lances or one rivet and one butterfly lance or another structural feature (e.g., knob, protrusion, projection, pin, bolt, etc.) that allows coupling onto bracket 400 via keyhole-shaped opening 409 and notch 411.

As discussed above, first surface 405 and second surface 407 meet at a first angle. In FIG. 4, the first angle is 90 degrees. However, in other contemplated embodiments, the first angle is between 75 and 125 degrees. Typically, the first angle is equal to an angle created by a first surface 402 meeting second surface 404 of vertical support member 401. For example, as shown in FIG. 4, vertical support member 401 has first surface 402 and second surface 404 having a plurality of apertures 403, the two surfaces form a 90 degree angle when they meet, which is equal to the first angle formed by first surface 405 and second surface 407. While the first angle and the angle formed by the major surface of support member 401 can be equal, it is contemplated that in other embodiments, the two angles are different from each other.

Keyhole-shaped opening 409 and notch 411 are typically positioned, such that notch 411 is directly above keyhole-shaped opening 409. It is contemplated that first surface 405 comprises an upper rim that defines the notch 411. In FIG. 4, notch 411 is directly above keyhole-shaped opening 409, such that a center point of each of keyhole-shaped opening 409 and notch 411 are aligned about a line that is parallel to a borderline where first surface 405 meets second surface 407.

In typical embodiments, a first distance 419 separates keyhole-shaped opening 409 and notch 411. First distance 419 is measured from the center point in the larger upper circular opening of keyhole-shaped opening 409 to the center point in the larger upper portion of notch 411 as shown in FIG. 4. A second distance 421 separates a first aperture and a second aperture of the plurality of apertures 403. Second distance 421 is measure from the center point in the larger upper circular opening of the first aperture to the center point in the larger upper circular opening of the second aperture as shown in FIG. 4. Although it is illustrated in FIG. 4 that first distance 419 is different from second distance 421, it is also contemplated that first distance 419 and second distance 421 can be the same.

A third distance 423 separates a first, upper and second, lower rivet of hinge 417. Third distance 423 is typically measured from the center point of the first rivet to the center point of the second rivet as shown in FIG. 4. It is preferred that third distance 423 is equal to or greater than first distance 419 to allow first and second rivets to mate with notch 411 and keyhole-shaped opening 409. Third distance 423 can be equal to second distance 421 where they are aligned, and third distance 423 and second distance 421 can be different where they are not aligned or misaligned.

When not aligned or misaligned, first and second rivets of hinge 417 cannot couple directly onto vertical support member 401 via apertures 403 since the larger upper circular opening of apertures 403 do not align with the first and second rivet of hinge 417. Thus, hinge 417 can indirectly attach to vertical support member 401 through use of bracket 400 via inserting first and second rivets into the larger upper circular portion of notch 411 and keyhole-shaped opening 409, respectively, and sliding first and second rivets or only second rivet into the smaller elongated opening extending downward from a lower end of the larger upper circular opening of notch 411 and keyhole-shaped opening 409.

In FIG. 4, first surface 405 and second surface 407 of bracket 400 are disposed about different major surfaces of vertical support member 401. As shown in FIG. 4, a first 402 and a second 404 surface are each one side of vertical support member 401. Second surface 407 of bracket 400 having at least one of (i) a rivet and (ii) a hole 413 that is sized and dimensioned to receive fastener 415 is coupled to first surface 402 of vertical support member 401. Once coupled, first surface 405 of bracket 400 is disposed about a second surface 404 of vertical support member 401. A gap defines a distance between first surface 405 of bracket 400 and second surface 404 of vertical support member 401, which allows first and second rivets of hinge 417 to insert into and slide down notch 411 and keyhole-shaped opening 409.

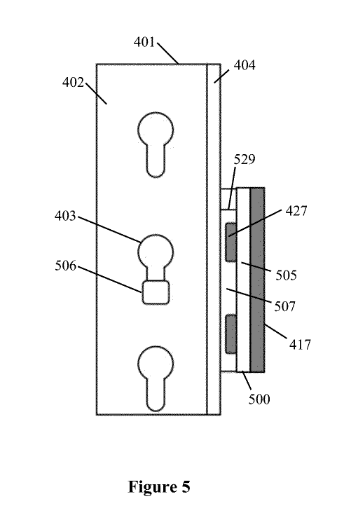

FIG. 5 shows a side view of bracket 500 coupled to vertical support member 401. Bracket 500 is the same bracket as bracket 400 in FIG. 4 except that bracket 500 has a rivet 506 on second surface 507 of bracket 500 rather than a hole as shown in bracket 400 in FIG. 4. Bracket 500 has a first surface 505 and a second surface 507 where first surface 505 has a notch and a keyhole-shaped opening and second surface has a rivet 506. Rivet 506 can be inserted into aperture 403 on the first surface 402 of vertical support member 401. As discussed above, a gap 529 is formed between second surface 404 of vertical support member 401 and first surface 505 of bracket 500. It is contemplated that gap 529 allows a rivet 427 of a hinge 417 to fit between first surface 505 of bracket 500 and second surface 404 of vertical support member 401 when hinge 517 is coupled to bracket 500 as shown in FIG. 5. Thus, second surface 507 of bracket 500 has a width that is greater than the width of first surface 402 of vertical support member 401, such that first surface 505 of bracket 500 and second surface 404 of vertical support member 401 define gap 529 relative to one another when bracket 500 is coupled to the vertical support member 501.

Bracket 500 has rivet 506 positioned on second surface 507, such that at least one of the keyhole-shaped opening and the notch are not aligned or misaligned with apertures 403 on the second surface 404 of vertical support member 401 when bracket 500 is coupled to vertical support member 501. In other words, at least one of the keyhole-shaped opening and notch is aligned with apertures 403 on second surface 404 of vertical support member. For example, the center of the relatively larger upper circular opening of the keyhole-shaped opening on bracket 500 and the center of an aperture 403 on second surface 404 (e.g., the center of larger upper circular opening of the keyhole-shaped aperture 403) do not form a horizontal line when bracket 500 is coupled to vertical support member 401.

It should be appreciated that not aligned or misaligned also includes overlapping where one of the keyhole-shaped opening or notch of bracket 500 overlaps an aperture 403 on second surface 404 of vertical support member 401, but the other of the keyhole-shaped opening or notch does not overlap an aperture 403 on second surface 404. Furthermore, not aligned or misaligned includes some overlapping by at least one of the keyhole-shaped opening and notch with at least one aperture 403 on second surface 404, but not complete overlapping by both the keyhole-shaped opening and notch with two apertures 403 on second surface 404 of vertical support member 401. Thus, it is contemplated that having at least one of a keyhole-shaped opening and the notch prevents rocking of a hinge 517 because rivet 427 of hinge 417 will not go inside an aperture 403 on the second surface 404 of vertical support member 401. Alternatively, it is also contemplated that gap 529 forms a space that is a tight fit for rivet 527, such that second surface 404 of vertical support member 401 contacts one side of rivet 427 of hinge 417 and first surface 505 of bracket contacts the other side of rivet 427.

In another aspect, a method is contemplated for attaching brackets 400, 500 to vertical support member 401 and hinge 417. The method comprises positioning brackets 400, 500 with vertical support member 401 to align one rivet 506 or a hole 413 of bracket 400, 500 with aperture 403 on the first surface 402 of vertical support member 401. Rivet 506 is inserted into aperture 403 and slid down to secure bracket 500 onto vertical support member 401 or a fastener 415 is used to couple bracket 400 to vertical support member 401 using hole 413 and aperture 403. At least one rivet 427 of hinge 417 can be inserted and slid down keyhole-shaped opening or slid down notch to secure hinge 417 to brackets 400, 500. It should be appreciated brackets 400, 500 can be coupled onto vertical support member 401 prior to coupling hinge 417 onto brackets 400, 500 or vice versa.

It is contemplated that the method can be performed in any suitable order. For example, in some embodiments, the step of sliding the rivet 506 of the bracket 400,500 or fastening the fastener 415 through the hole 413 of the bracket 400,500 is performed prior to the step of sliding at least one rivet of the hinge 417 into at least one of the keyhole-shaped opening and the notch. In other embodiments, the step of sliding at least one rivet of the hinge 417 into at least one of the keyhole-shaped opening and the notch is performed prior to sliding the rivet 506 of the bracket 400,500 or fastening the fastener 415 through the hole 413 of the bracket 400,500.

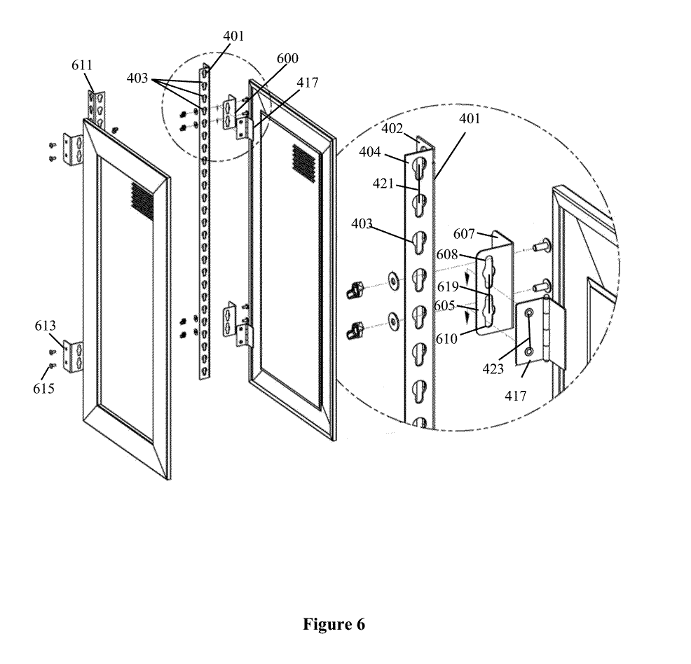

In another embodiment, a bracket 600 for detachably connecting to vertical support member 401 having a plurality of apertures 403 is contemplated as shown in FIG. 6. Bracket 600 has a first surface 605 having a first opening 608 and a second opening 610. A second surface 607 meets first surface 605 at a first angle, and second surface 607 has at least one of a rivet and a hole 613 sized and dimensioned to receive a fastener 615. First opening 608 and second opening 610 are substantially elongated having a widened center area. However, it is contemplated that one of the first opening 608 and second opening 610 is substantially elongated having a widened center area and the other has a keyhole-shaped opening or a notch.

It should be appreciated that having the shape of first 608 and second 610 openings allows bracket 600 to be used in different orientations. For example, bracket 600 can be coupled to vertical support member 401 for attaching a right door hinge (e.g., hinge 417) onto vertical support member 401. Alternatively, bracket 600 can be rotated 180 degrees such that second opening 610 is above the first opening 608 to attach the left door hinge to second vertical support member 611. Thus, bracket 600 can attach to either a left or right vertical support member thereby reducing the number of distinct parts needed to assemble storage rack 100.

Bracket 600 has a first angle that is between 75 and 125 degrees. In some embodiments, the first angle can be 90 degrees and, in other embodiments, the first angle is equal to the angle created by first surface 402 meeting second surface 404 of vertical support member 401. As shown in FIG. 6, first opening 608 is aligned directly above second opening 610. In other words, a center point of each of first opening 608 and second opening 610 are aligned about a line that is parallel to the borderline where first surface 605 meets second surface 607.

Similar to the previous embodiment, a first distance 619 separates first opening 608 and second opening 610, and a second distance 421 separates a first aperture and a second aperture of the plurality of apertures 403, and first distance 619 and second distance 421 are different. The first distance is typically measured from the center of the widened center area of first opening 608 to the center of the widened center area of second opening 610 as shown in FIG. 6. As discussed above, second distance 421 is measured from the center of the upper, circular area of aperture to the center of the upper, circular area of an adjacent aperture as shown in FIG. 6. However, in other contemplated embodiments, first distance 619 and second distance 421 are the same distance. It should be appreciated that bracket 600 can function as an adapter for devices that do not share the same spacing as vertical support member 401.

A hinge 417 having a first rivet and a second rivet can couple bracket 600. The first rivet and the second rivet are separated by a third distance 423 that is measured from the center of the first rivet to the center of the second rivet. Third distance 423 is typically equal to or greater than first distance 619 to allow at least one of the rivets of hinge 417 to be inserted into and slid down at least one of the first 608 and second 610 openings. Third distance 423 is typically different than second distance 421. As discussed above, it is contemplated that hinge 417 is a hinge bracket, a bracket for a hook, a bracket for a basket, and so forth.

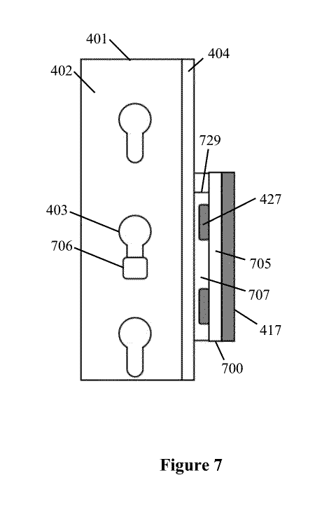

FIG. 7 shows a side view of vertical support member 401 with a coupled bracket 700. Bracket 700 is the same as bracket 600 except that bracket 700 has a rivet 706 disposed on second surface 707 instead of a hole 613 for a fastener 615 as in bracket 600. Much like the embodiments described above, a gap 729 remains between first surface 705 of bracket 700 and second surface 404 of vertical support member 401 to allow at least one of the rivets from hinge 417 to fit within gap 729. Thus, second surface 707 has a width greater than a width of first surface 402 of vertical support member 401, such that first surface 705 and second surface 404 of vertical support member 401 define gap 729 relative to one another when bracket 700 is coupled to vertical support member 401. Although gap 729 allows some spacing between a rivet 427 of hinge 417 and second surface 404 of vertical support member 401, it is contemplated that gap 729 is a tight fit for rivet 427 so that rivet 427 contacts second surface 404 of vertical support member.

As similarly discussed above, rivet 706 or hole 613 are positioned on second surface 607, 707, such that the first opening and the second opening of bracket 600, 700 are not aligned or misaligned with any of the plurality of apertures 403 when bracket 600, 700 couples vertical support member 401. This misalignment prevents rocking caused by rivet 427 of hinge 417 entering an aperture 403 on second surface 404 of vertical support member 401. It should be appreciated that not aligned or misaligned includes overlapping as discussed above.

In another aspect, a method of attaching bracket 600, 700 to vertical support member 401 having a plurality of apertures 403 and hinge 417 having rivets 427 is contemplated. The method comprises positioning bracket 600, 700 with vertical support member 401 to align rivet 706 or hole 613 of bracket 600, 700 with an aperture of the plurality of apertures 403. Rivet 706 is inserted into an aperture of the plurality of apertures 403 and slid down to couple bracket 700 to vertical support member 401 or fastener 615 is used to fasten bracket 600 to vertical support member 401 through an aperture of the plurality of apertures 403 and hole 613. As shown in FIG. 6, it is contemplated that a second hole and second fastener is used to fasten bracket 600 to vertical support member 401. Once bracket 600, 700 are coupled to the vertical support member 401, a hinge 417 can be coupled to the bracket 600, 700. At least one rivet of hinge 417 is inserted into at least one of first opening 608 and second opening 610 and slid down to attach hinge 417 onto bracket 600, 700. It is contemplated that hinge 417 can be attached to bracket 600, 700 prior to coupling bracket 600, 700 to vertical support member 401. Thus, bracket 600, 700 can be used as an adapter for attaching hinge 417 onto vertical support member 401.

It is contemplated that the method can be performed in any suitable order. For example, in some embodiments, the step of sliding the rivet 706 of the bracket 600, 700 or fastening the fastener 615 through the hole 613 of the bracket 400,500 is performed prior to the step of sliding at least one rivet of the hinge 417 into at least one of the keyhole-shaped opening and the notch. In other embodiments, the step of sliding at least one rivet of the hinge 417 into at least one of the keyhole-shaped opening and the notch is performed prior to sliding the rivet 506 of the bracket 600, 700 or fastening the fastener 615 through the hole 613 of the bracket 600, 700.

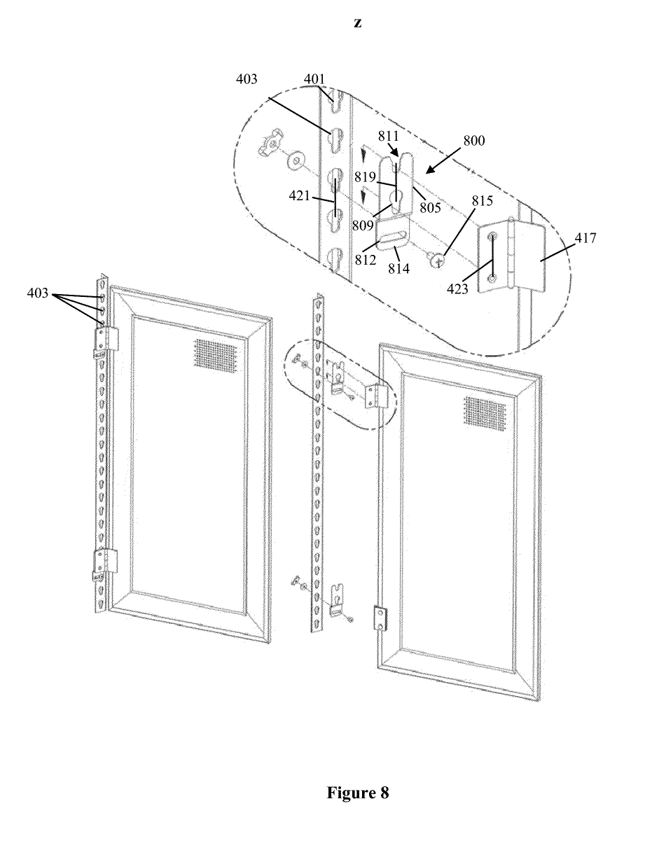

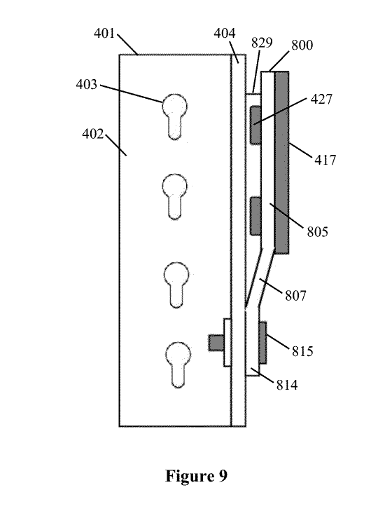

In yet another embodiment, a bracket 800 for detachably connecting to vertical support member 401 having a plurality of apertures 403 is contemplated as shown in FIGS. 8 and 9. Bracket 800 comprises a first surface 805 having a keyhole-shaped opening 809 and a notch 811. A second surface 807 meets first surface 805 at a first angle, and a third surface 814 meets second surface 807 at a second angle as shown in the side view of bracket 800 in FIG. 9. Third surface 814 has a slot 812 that is sized and dimensioned to receive a fastener 815. Additionally, or alternatively, third surface 814 can have at least one of a rivet that can be used to couple bracket 800 to vertical support member via an aperture of the plurality of apertures 403, and a circular hole for a fastener to fasten bracket 800 to vertical support member 401.

First surface 805 comprises an upper rim that defines notch 811. As shown in FIG. 8, notch 811 defines a lower portion of a keyhole-shaped opening. However, in other embodiments, notch 811 can have a circular shape.

A first distance 819 separates keyhole-shaped opening 809 and notch 811 as shown in FIG. 8. First distance 819 is measured from the center of the upper, circular area of keyhole-shaped opening 809 to the center of the larger, upper portion of notch 811. A second distance 421 separates a first aperture and a second aperture of the plurality of apertures 403. Second distance 421 is measured as described above. First distance 819 and second distance 421 are different in FIGS. 8-9. However, in other embodiments, first distance 819 and second distance 421 can be the same.

The rivet or slot 812 of bracket 800 can be positioned on third surface 814, such that keyhole-shaped opening 809 and notch 811 are not aligned with any of the plurality of apertures when the bracket couples the vertical support member. As discussed in some of the other embodiments above, not aligned or misaligned includes overlapping where at least one of the keyhole-shaped opening 809 and notch 811 partially overlaps with at least one aperture of the plurality of apertures. It should be appreciated that such orientation prevents a rivet from a hinge 417 from entering an aperture of the plurality of apertures 403 and cause rocking of hinge 417 when hinge 417 is coupled to bracket 800.

hinge 417, which could be a hinge bracket, hook bracket, basket bracket or a bracket to hold some other device, has a first and second rivet that are separated by a third distance 423. Third distance 423 is equal to or greater than first distance 819 to allow the rivets of hinge 417 to engage notch 811 and keyhole-shaped opening 809 to couple hinge 417 to bracket 800. It is also contemplated that third distance 423 is different than second distance 421.

Similar to the embodiments described above, a gap 829 is formed between second surface 404 of vertical support member 401 and first surface 805 of bracket 800 as shown in the side view in FIG. 9. It is contemplated that second surface 807 has a height, such that first surface 805 of bracket 800 and second surface 404 of vertical support member 401 define gap 829 when bracket 800 is coupled to vertical support member 401. Gap 829 can be decreased to provide a tight fit for rivet 427, such that first surface 805 of bracket 800 is contacting one side of rivet 427 and second surface 404 of vertical support member 401 is contacting the other surface of rivet 427.

In another aspect, a method of attaching bracket 800 to vertical support member 401 is contemplated. The method comprises positioning bracket 800 with vertical support member 401 to align a rivet or slot 812 of bracket 800 with an aperture of the plurality of apertures 403. In another step, the rivet is inserted into and slid down the aperture on vertical support member 401 or a fastener 815 is used to fasten bracket 800 to vertical support member through the aperture on vertical support member 401 and slot 812. Once bracket 800 is coupled to vertical support member 401, at least one rivet from hinge 417 is inserted into at least one of keyhole-shaped opening 809 and notch 411 and slid down to couple hinge 417 to bracket 800. It should be appreciated that it is also contemplated that hinge 417 is coupled to bracket 800 prior to bracket 800 coupling to vertical support member 401.

It is contemplated that the method can be performed in any suitable order. For example, in some embodiments, the step of sliding the rivet 812 of the bracket 800 or fastening the fastener 815 through the slot 812 of the bracket 800 is performed prior to the step of sliding at least one rivet of the hinge 417 into at least one of the keyhole-shaped opening and the notch. In other embodiments, the step of sliding at least one rivet of the hinge 417 into at least one of the keyhole-shaped opening and the notch is performed prior to sliding the rivet 812 of the bracket 800 or fastening the fastener 815 through the slot 812 of the bracket 800.

It should be appreciated that bracket 800 has slot 812, which allows bracket 800 to be slid left or right while bracket 800 is coupled to vertical support member 401. This is beneficial when adjusting for a gap between doors that use a hinge assembly as described above since a user can simply slide a bracket 800 having a coupled hinge assembly to eliminate/reduce the gap. Furthermore, bracket 800 can be used in either a left or right vertical support member.

Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, the terms “coupled to” and “coupled with” are used euphemistically in a networking context to mean “communicatively coupled with” where two or more devices are configured to exchange data (e.g., uni-directionally, bi-directionally, peer-to-peer, etc.) with each other possibly via one or more intermediary devices.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A bracket for detachably connecting a hinge to a vertical support member having a plurality of apertures, the bracket comprising:
a first surface having a keyhole-shaped opening and a notch; and
a second surface that meets the first surface at a first angle, and having at least one of (i) a rivet and (ii) a hole sized and dimensioned to receive a fastener.

2. The bracket of claim 1, wherein the first angle is equal to an angle created by two surfaces of the vertical support member that meet.

3. The bracket of claim 1, wherein a center point of each of the keyhole-shaped opening and the notch are aligned about a line that is parallel to a borderline where the first surface meets the second surface.

4. The bracket of claim 1, wherein a first distance separates the keyhole-shaped opening and the notch, and a second distance separates a first aperture and a second aperture of the plurality of apertures, and wherein the first distance and the second distance are different.

5. The bracket of claim 4, wherein the at least one the rivet or the hole is positioned on the second surface, such that at least one of the keyhole-shaped opening and the notch are not aligned with any of the plurality of apertures when the bracket couples the vertical support member.

6. The bracket of claim 1, wherein the second surface has a width greater than a width of the vertical support member, such that the first surface and the vertical support member define a gap relative to one another when the bracket is coupled to the vertical support member.

7. The bracket of claim 1, further comprising a hinge having a first rivet and a second rivet that are separated by a third distance, and a first distance separates the keyhole-shaped opening and the notch, and wherein the third distance is greater than the first distance.

8. A bracket for detachably connecting to a vertical support member having a plurality of apertures, the bracket comprising:
a first surface having a first opening and a second opening;
a second surface that meets the first surface at a first angle, and having at least one of (i) a rivet and (ii) a hole sized and dimensioned to receive a fastener; and
wherein at least one of the first opening and the second opening is substantially elongated having a widened area.

9. The bracket of claim 8, wherein the first angle is equal to an angle created by two surfaces of the vertical support member that meet.

10. The bracket of claim 8, wherein a center point of each of the first opening and the second opening are aligned about a line that is parallel to a borderline where the first surface meets the second surface.

11. The bracket of claim 8, wherein at least one of the first opening and second opening is a keyhole-shaped opening.

12. The bracket of claim 8, wherein a first distance separates the first opening and the second opening, and a second distance separates a first aperture and a second aperture of the plurality of apertures, and wherein the first distance and second distance are different.

13. The bracket of claim 12, wherein the at least one of a rivet or a hole is positioned on the second surface, such that the first opening and the second opening are not aligned with any of the plurality of apertures when the bracket couples the vertical support member.

14. The bracket of claim 8, wherein the second surface has a width greater than a width of the vertical support member, such that the first surface and the vertical support member define a gap relative to one another when the bracket is coupled to the vertical support member.

15. The bracket of claim 8, further comprising a hinge having a first rivet and a second rivet that are separated by a third distance, and a first distance separates the first opening and the second opening, and wherein the third distance is greater than the first distance.

16. A bracket for detachably connecting to a vertical support member having a plurality of apertures, the bracket comprising:
a first surface having a keyhole-shaped opening and a notch;
a second surface that meets the first surface at a first angle; and
a third surface that meets the second surface at a second angle, and having at least one of (i) a rivet and (ii) a slot sized and dimensioned to receive a fastener.

17. The bracket of claim 16, wherein a first distance separates the keyhole-shaped opening and the notch, and a second distance separates a first aperture and a second aperture of the plurality of apertures, and wherein the first distance and the second distance are different.

18. The bracket of claim 19, wherein the at least one of a rivet or a slot is positioned on the third surface, such that the keyhole-shaped opening and the notch are not aligned with any of the plurality of apertures when the bracket couples the vertical support member.

19. The bracket of claim 16, the second surface has a height, such that the first surface and the vertical support member define a gap relative to one another when the bracket is coupled to the vertical support member.

20. The bracket of claim 16, further comprising a hinge having a first rivet and a second rivet that are separated by a third distance, and a first distance separates the keyhole-shaped opening and the notch, and wherein the third distance is greater than the first distance.
